(19) United States
(12) Patent Application Publication
(10) Pub. No.: US 2026/0371320 A1
(43) Pub. Date: Nov. 19, 2026

(54) METHOD AND DEVICE FOR DETERMINING RESOURCE, COMMUNICATION DEVICE, AND STORAGE MEDIUM

(71) Applicant: Beijing Xiaomi Mobile Software Co., Ltd., Beijing (CN)

(72) Inventor: Lei WANG, Beijing (CN)

(73) Assignee: Beijing Xiaomi Mobile Software Co., Ltd., Beijing (CN)

(21) Appl. No.: 19/145,768

(22) PCT Filed: Jan. 6, 2023
(86) PCT No.: PCT/CN2023/071111

§ 371 Date: Jul. 3, 2025

(51) Int. Cl. H04W 72/0446

(52) U.S. Cl. CPC H04W 72/0446

(57) ABSTRACT

A method for determining resources, performed by a terminal, the method including: determining that a first resource for transmitting a demodulation reference signal of a physical uplink shared channel overlaps with a second resource in an uplink subband configured for the terminal, where the second resource is not used for transmitting the demodulation reference signal; and determining an available third resource, and transmitting the demodulation reference signal on the third resource.

### CROSS-REFERENCE TO RELATED APPLICATION

The present application is a U.S. National Stage of International Application No. PCT/CN2023/071111, filed on Jan. 6, 2023, the contents of all of which are incorporated herein by reference in their entirety for all purposes.

### BACKGROUND OF THE INVENTION

In order to achieve full-duplex communication of a terminal, a network device may configure a subband for the terminal on a slot. For example, the network device may configure an uplink subband for the terminal on a downlink slot. In this way, in the downlink slot, the terminal may perform uplink communication by using a frequency domain resource of the uplink subband, and/or perform downlink communication on a frequency domain resource outside the uplink subband.

### SUMMARY OF THE INVENTION

The present disclosure relates to the technical field of communication, and particularly relates to a method for determining resources, a device for determining resources, a system for determining resources, a communication device, and a non-transitory computer-readable storage medium.

According to a first aspect of the embodiments of the present disclosure, a method for determining resources is provided. The method for determining resources is performed by a terminal and includes: determining that a first resource for transmitting a demodulation reference signal of a physical uplink shared channel overlaps with a second resource in an uplink subband configured for the terminal, where the second resource is not used for transmitting the demodulation reference signal; and determining an available third resource, and transmitting the demodulation reference signal on the third resource.

According to a second aspect of the embodiments of the present disclosure, a method for determining resources is provided. The method for determining resources is performed by a network device and includes: determining that a first resource for transmitting a demodulation reference signal of a physical uplink shared channel by a terminal overlaps with a second resource in an uplink subband configured for the terminal, where the second resource is not used for transmitting the demodulation reference signal; and determining an available third resource, and receiving on the third resource the demodulation reference signal transmitted by the terminal.

According to a third aspect of the embodiments of the present disclosure, a device for determining resources is provided. The device for determining resources includes: a processing module configured to determine that a first resource for transmitting a demodulation reference signal of a physical uplink shared channel overlaps with a second resource in an uplink subband configured for the terminal and to determine an available third resource, where the second resource is not used for transmitting the demodulation reference signal; and a transmitting module configured to transmit the demodulation reference signal on the third resource.

According to a fourth aspect of the embodiments of the present disclosure, a device for determining resources is provided. The device for determining resources includes: a processing module configured to determine that a first resource for transmitting a demodulation reference signal of a physical uplink shared channel by a terminal overlaps with a second resource in an uplink subband configured for the terminal and to determine an available third resource, where the second resource is not used for transmitting the demodulation reference signal; and a receiving module configured to receive on the third resource the demodulation reference signal transmitted by the terminal.

According to a fifth aspect of the embodiments of the present disclosure, a system for determining resources is provided. The system for determining resources includes a terminal and a network device, where the terminal is configured to implement the method for determining resources performed by the terminal in any one of the embodiments, and the network device is configured to implement the method for determining resources performed by the network device in any one of the embodiments.

According to a sixth aspect of the embodiments of the present disclosure, a communication device is provided. The communication device includes one or more processors and a memory configured to store a computer program, where the computer program, when executed by the one or more processors, implements the method for determining resources performed by the terminal in any one of the embodiments.

According to a seventh aspect of the embodiments of the present disclosure, a communication device is provided. The communication device includes one or more processors and a memory configured to store a computer program, where the computer program, when executed by the one or more processors, implements the method for determining resources performed by the network device in any one of the embodiments.

According to an eighth aspect of the embodiments of the present disclosure, a non-transitory computer-readable storage medium is provided. The non-transitory computer-readable storage medium is used for storing a computer program, where the computer program, when executed by one or more processors, implements the method for determining resources performed by the terminal in any one of the embodiments.

According to a ninth aspect of the embodiments of the present disclosure, a non-transitory computer-readable storage medium is provided. The non-transitory computer-readable storage medium is used for storing a computer program, where the computer program, when executed by one or more processors, implements the method for determining resources performed by the network device in any one of the embodiments.

### BRIEF DESCRIPTION OF DRAWINGS

In order to describe the technical solutions in the embodiments of the present disclosure more clearly, the accompanying drawings required to be used in the descriptions of the embodiments will be briefly introduced below. The accompanying drawings in the following descriptions show merely some embodiments of the present disclosure. A person of ordinary skill in the art may derive other accompanying drawings according to these accompanying drawings without making creative efforts.

FIG. 1 is a schematic flowchart of a method for determining resources according to an embodiment of the present disclosure.

FIG. 2 is a schematic diagram of a plurality of types of uplink subbands according to an embodiment of the present disclosure.

FIG. 3 is a schematic diagram showing a plurality of types of relationships between an uplink resource for uplink transmission and a second resource according to an embodiment of the present disclosure.

FIG. 4 is a schematic diagram showing a relationship between an uplink resource for uplink transmission and a second resource according to an embodiment of the present disclosure.

FIG. 5A is a schematic flowchart of another method for determining resources according to an embodiment of the present disclosure.

FIG. 5B is a schematic diagram of an available third resource according to an embodiment of the present disclosure.

FIG. 6A is a schematic flowchart of yet another method for determining resources according to an embodiment of the present disclosure.

FIG. 6B is a schematic diagram of another available third resource according to an embodiment of the present disclosure.

FIG. 7A is a schematic flowchart of yet another method for determining resources according to an embodiment of the present disclosure.

FIG. 7B is a schematic diagram showing a relationship between an uplink resource for uplink transmission and a second resource according to an embodiment of the present disclosure.

FIG. 7C is a schematic diagram of yet another available third resource according to an embodiment of the present disclosure.

FIG. 8A is a schematic flowchart of still another method for determining resources according to an embodiment of the present disclosure.

FIG. 8B is a schematic diagram of still another available third resource according to an embodiment of the present disclosure.

FIG. 9 is a schematic flowchart of a method for determining resources according to an embodiment of the present disclosure.

FIG. 10 is a schematic block diagram of a device for determining resources according to an embodiment of the present disclosure.

FIG. 11 is a schematic block diagram of a device for determining resources according to an embodiment of the present disclosure.

FIG. 12 is a schematic block diagram of a device for determining resources according to an embodiment of the present disclosure.

FIG. 13 is a schematic block diagram of a device for determining resources according to an embodiment of the present disclosure.

### DETAILED DESCRIPTION OF THE INVENTION

The technical solutions of the embodiments of the present disclosure will be clearly and completely described in combination with the accompanying drawings of the embodiments of the present disclosure. The described embodiments are merely some embodiments rather than all embodiments of the present disclosure. Based on the embodiments of the present disclosure, all other embodiments derived by a person of ordinary skill in the art without making creative efforts all fall within the scope of protection of the present disclosure.

Terms used in the embodiments of the present disclosure are merely used for describing particular embodiments, and are not intended to limit the embodiments of the present disclosure. Singular forms such as “a,” “an,” and “the” used in the embodiments of the present disclosure and the appended claims are also intended to include plural forms, unless otherwise clearly stated in the context. It is to be further understood that the term “and/or” used in the present disclosure refers to and includes any or all possible combinations of one or more of associated listed items.

It is to be understood that although terms such as first, second and third may be used in the embodiments of the present disclosure to describe various types of information, such information does not be limited to these terms. These terms are merely used for distinguishing the same type of information from each other. For example, without departing from the scope of the embodiments of the present disclosure, first information may alternatively be referred to as second information. Similarly, second information may alternatively be referred to as first information. Depending on the context, the word “if” as used in the present disclosure may be interpreted as “when,” “in a case where,” or “in response to determining”.

For purposes of concision and ease of understanding, terms “greater than” or “less than” and “higher than” or “lower than” are used in the present disclosure to represent size relationships. A person skilled in the art may understand that the term “greater than” further encompasses the meaning of “greater than or equal to”, the term “less than” further encompasses the meaning of “less than or equal to”, the term “higher than” further encompasses the meaning of “higher than or equal to”, and the term “lower than” further encompasses the meaning of “lower than or equal to”.

A current manner for a terminal to perform communication by using a subband has some problems.

In an embodiment, a network device may configure a downlink subband for a terminal in an uplink slot. In a case where the network device may perform full-duplex communication and the terminal may perform half-duplex communication, in the uplink time domain unit, the terminal may perform downlink communication in the downlink subband or perform uplink communication on a frequency domain resource outside the downlink subband. In a case where both the network device and the terminal may perform full-duplex communication, in the uplink time domain unit, the terminal may perform downlink communication in the downlink subband and perform uplink communication on a frequency domain resource outside the downlink subband.

In an embodiment, the network device may configure an uplink subband for the terminal in a downlink slot. In a case where the network device may perform full-duplex communication and the terminal may perform half-duplex communication, in the downlink time domain unit, the terminal may perform uplink communication in the uplink subband or perform downlink communication on a frequency domain resource outside the uplink subband. In a case where both the network device and the terminal may perform full-duplex communication, in the downlink time domain unit, the terminal may perform uplink communication in the uplink subband and perform downlink communication on a frequency domain resource outside the uplink subband.

In a case where the network device configures an uplink subband for the terminal in a downlink slot, the terminal may perform uplink transmission in the uplink subband, for example, transmit a physical uplink shared channel (PUSCH) and a demodulation reference signal (DMRS) of the PUSCH to the network device. Moreover, in the uplink subband, the network device may further configure for the terminal some resources not used for transmitting the DMRS. In a case where the resource used for transmitting the DMRS overlaps with the resource not used for transmitting the DMRS, the DMRS, which is used for a demodulation related operation for the PUSCH, cannot be normally transmitted, degrading transmission performance of the PUSCH.

FIG. 1 is a schematic flowchart of a method for determining resources according to an embodiment of the present disclosure. The method for determining resources shown in the embodiment may be performed by a terminal. The terminal includes but is not limited to a communication device such as a mobile phone, a tablet computer, a wearable device, a sensor, and an internet of things device. The terminal may be in communication with a network device. The network device includes but is not limited to a network device in a 4G, 5G, 6G, and other communication systems, such as a base station and a core network.

As shown in FIG. 1, the method for determining resources may include steps S101 and S102.

Step S101 includes determining that a first resource for transmitting a demodulation reference signal of a physical uplink shared channel overlaps with a second resource in an uplink subband configured for the terminal, where the second resource is not used for transmitting the demodulation reference signal.

Step S102 includes determining an available third resource, and transmitting the demodulation reference signal on the third resource.

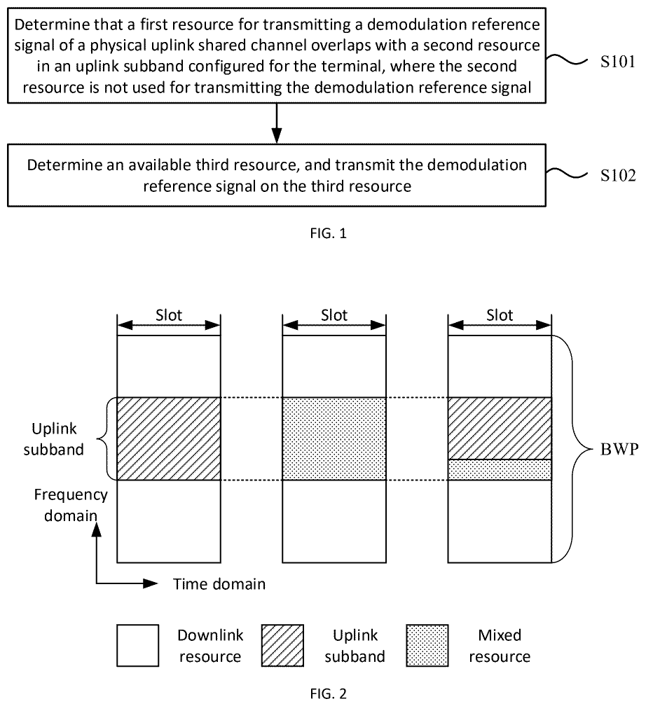

FIG. 2 is a schematic diagram of a plurality of types of uplink subbands according to an embodiment of the present disclosure.

A network device may configure an uplink subband for the terminal in a downlink slot. Taking a frequency domain resource corresponding to the downlink slot including one bandwidth part (BWP) as an example.

In an embodiment, as shown in a slot at a left side of FIG. 2, in the downlink slot, a frequency domain resource corresponding to the uplink subband does not overlap with a frequency domain resource corresponding to a downlink resource for downlink reception.

In an embodiment, as shown in a slot in the middle of FIG. 2, in the downlink slot, a frequency domain resource corresponding to the uplink subband completely overlaps with a frequency domain resource corresponding to a downlink resource for downlink reception.

In an embodiment, as shown in a slot at a right side of FIG. 2, in the downlink slot, a frequency domain resource corresponding to the uplink subband partially overlaps with a frequency domain resource corresponding to a downlink resource for downlink reception.

The following embodiments are described with an example in which a frequency domain resource corresponding to the uplink subband does not overlap with a frequency domain resource corresponding to a downlink resource for downlink reception in the downlink slot.

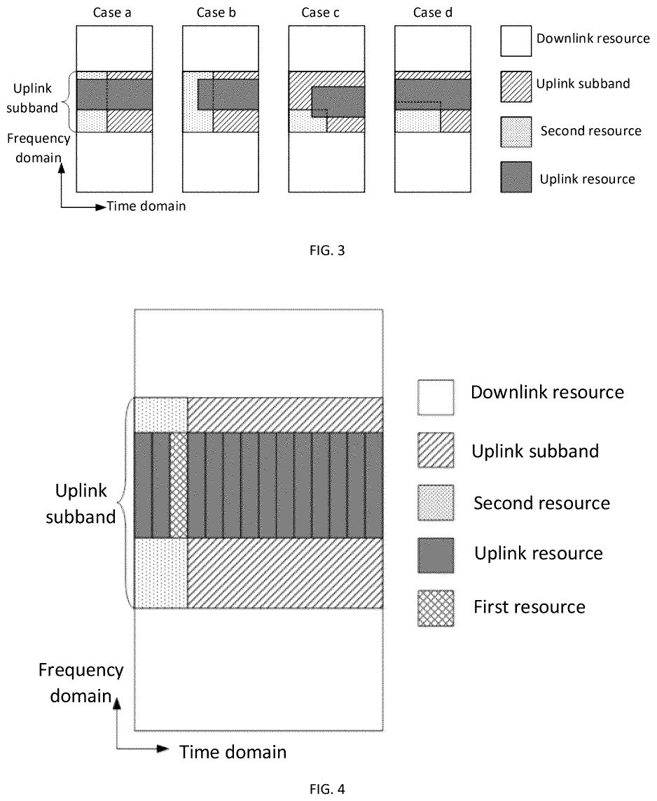

FIG. 3 is a schematic diagram showing a plurality of types of relationships between an uplink resource for uplink transmission and the second resource according to an embodiment of the present disclosure.

For example, in Case a in FIG. 3, the network device configures an uplink subband for the terminal in a downlink slot. The uplink subband corresponds to the entire downlink slot in a time domain. An uplink resource for uplink transmission in the uplink subband corresponds to a portion of the uplink subband in a frequency domain, and corresponds to the entire slot in the time domain. The second resource corresponds to the entire uplink subband in the frequency domain, and corresponds to a portion of the slot in the time domain. The uplink resource for uplink transmission in the uplink subband overlaps with the second resource.

For example, in Case b in FIG. 3, the network device configures an uplink subband for the terminal in a downlink slot. The uplink subband corresponds to the entire downlink slot in a time domain. An uplink resource for uplink transmission in the uplink subband corresponds to a portion of the uplink subband in a frequency domain, and corresponds to a portion of the slot in the time domain. The second resource corresponds to the entire uplink subband in the frequency domain, and corresponds to a portion of the slot in the time domain. The uplink resource for uplink transmission in the uplink subband overlaps with the second resource.

For example, in Case c in FIG. 3, the network device configures an uplink subband for the terminal in a downlink slot. The uplink subband corresponds to the entire downlink slot in a time domain. An uplink resource for uplink transmission in the uplink subband corresponds to a portion of the uplink subband in a frequency domain, and corresponds to a portion of the slot in the time domain. The second resource corresponds to a portion of the uplink subband in the frequency domain, and corresponds to a portion of the slot in the time domain. The uplink resource for uplink transmission in the uplink subband overlaps with the second resource.

For example, in Case d in FIG. 3, the network device configures an uplink subband for the terminal in a downlink slot. The uplink subband corresponds to the entire downlink slot in a time domain. An uplink resource for uplink transmission in the uplink subband corresponds to a portion of the uplink subband in a frequency domain, and corresponds to the entire slot in the time domain. The second resource corresponds to a portion of the uplink subband in the frequency domain, and corresponds to a portion of the slot in the time domain. The uplink resource for uplink transmission in the uplink subband overlaps with the second resource.

It needs to be noted that FIG. 3 merely illustrates a plurality of types of cases where the uplink resource for uplink transmission in the uplink subband overlaps with the second resource. However, cases where the uplink resource for uplink transmission in the uplink subband overlaps with the second resource are not limited to the cases shown in FIG. 3.

FIG. 4 is a schematic diagram showing a relationship between an uplink resource for uplink transmission and the second resource according to an embodiment of the present disclosure.

In an embodiment, one slot may include fourteen symbols. The symbols may be orthogonal frequency division multiplexing (OFDM) symbols.

Taking Case a in FIG. 3 as an example, the resource for transmitting the PUSCH corresponds to the entire slot in the time domain, that is, corresponds to a first symbol to a fourteenth symbol, and the second resource corresponds to the first symbol to a third symbol in the time domain. A type of the PUSCH is PUSCH mapping type A, and the network device does not indicate an additional DMRS for the terminal. In this case, the DMRS of the PUSCH may be located at a second or the third symbol in the slot.

For example, as shown in FIG. 4, taking the DMRS being located at the third symbol in the slot as an example, the first resource (that is, the third symbol) for transmitting the DMRS overlaps with the second resource (that is, the first symbol to the third symbol) on the third symbol. Since the second resource is not used for transmitting the DMRS, the DMRS cannot be normally transmitted on the third symbol. However, the DMRS is used for a demodulation related operation for the PUSCH. Accordingly, transmission performance of the PUSCH is degraded.

According to the embodiment, in a case where it is determined that, in the uplink subband, the first resource for transmitting the DMRS of the PUSCH by the terminal overlaps with the second resource not used for transmitting the DMRS, the available third resource may be determined. For example, the third resource may be a resource in the uplink subband that does not overlap with the second resource. Then, the DMRS is transmitted on the third resource. Thus, normal transmission of the DMRS may be ensured, and desirable transmission performance of the PUSCH may be ensured.

In addition, after the third resource is determined, the terminal may, on a resource where the first resource overlaps with the second resource, transmit nothing or transmit the PUSCH.

In an embodiment, the second resource includes a rate matching resource (RMR), that is, a resource for rate matching.

In an embodiment, a terminal for which an uplink subband is configured in a downlink slot may perform uplink transmission in the uplink subband of the downlink slot. This terminal may be referred to as a subband full duplex (SBFD) terminal. A terminal for which no uplink subband is configured in a downlink slot may receive merely downlink transmission in the downlink slot. This terminal may be referred to as a legacy terminal.

The network device may schedule downlink transmission of the legacy terminal in the downlink slot. The downlink transmission includes but is not limited to a semi-static physical downlink shared channel (PDSCH), a dynamic PDSCH, a physical downlink control channel (PDCCH), a channel state information reference signal (CSI-RS), a positioning reference signal (PRS), etc.

In a case where the downlink transmission overlaps with the uplink subband, the uplink transmission of the SBFD terminal in the uplink subband may be interfered. In order to resolve this problem, the network device may configure a rate matching resource for the SBFD terminal in the uplink subband, and the SBFD terminal may perform rate matching according to the rate matching resource. Thus, collision between the downlink transmission and the uplink subband may be avoided. In the rate matching resource, the SBFD terminal cannot transmit the DMRS. Thus, the second resource may include the rate matching resource.

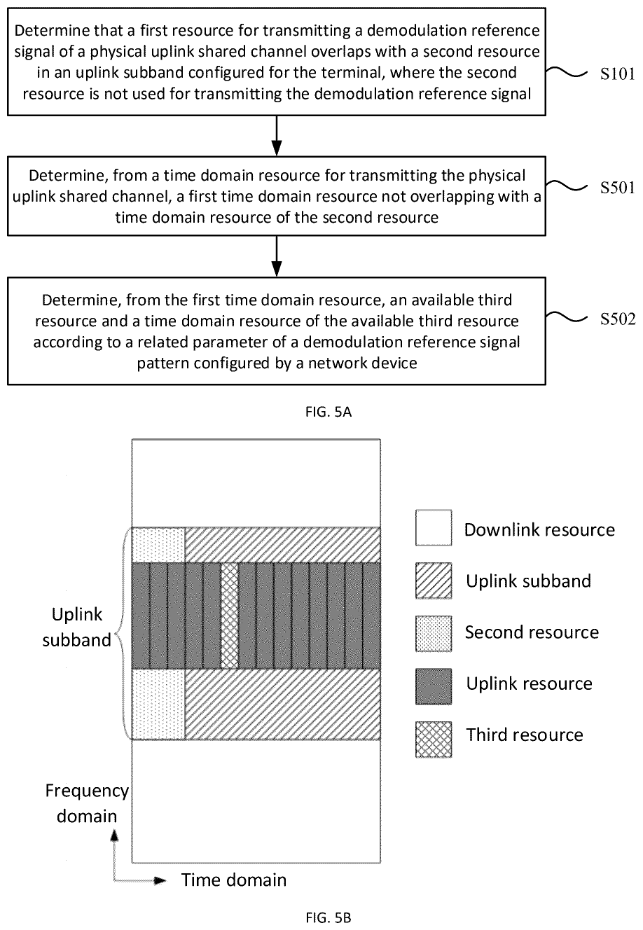

FIG. 5A is a schematic flowchart of another method for determining resources according to an embodiment of the present disclosure. As shown in FIG. 5A, determining the available third resource may include steps S501 and S502, in addition to previously described step S101.

Step S501 includes determining, from a time domain resource for transmitting the physical uplink shared channel, a first time domain resource not overlapping with a time domain resource of the second resource.

Step S502 includes determining a time domain resource of the available third resource from the first time domain resource according to a related parameter of a demodulation reference signal pattern configured by the network device.

In an embodiment, the time domain resource for transmitting the PUSCH may include the first time domain resource not overlapping with the time domain resource of the second resource. In this case, the terminal may determine a time domain resource from the first time domain resource as the time domain resource of the available third resource according to the related parameter of the demodulation reference signal pattern configured by the network device.

FIG. 5B is a schematic diagram of an available third resource according to an embodiment of the present disclosure.

For example, as shown in FIG. 5B, based on FIG. 4, the time domain resource for transmitting the PUSCH includes the first symbol to the fourteenth symbol, and a fourth symbol to the fourteenth symbol do not overlap with the second resource. In this case, the terminal may determine the available third resource from the fourth symbol to the fourteenth symbol according to the related parameter of the DMRS pattern configured by the network device. For example, the related parameter of the DMRS pattern includes a demodulation reference signal type A position, that is, dmrs-TypeA-Position. It may be determined according to this related parameter that a sixth symbol is the time domain resource of the available third resource. Accordingly, the terminal may transmit the DMRS on the sixth symbol.

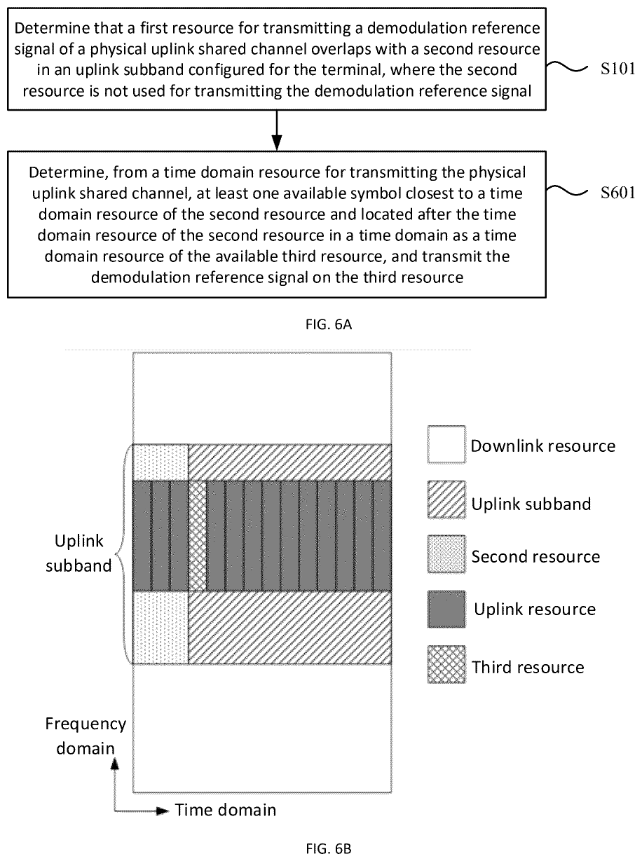

FIG. 6A is a schematic flowchart of yet another method for determining resources according to an embodiment of the present disclosure. As shown in FIG. 6A, determining the available third resource may include step S601, in addition to previously described step S101.

Step S601 includes determining, from a time domain resource for transmitting the physical uplink shared channel, at least one available symbol closest to a time domain resource of the second resource and located after the time domain resource of the second resource in a time domain as a time domain resource of the available third resource.

In an embodiment, the terminal may determine, from the time domain resource for transmitting the PUSCH, at least one available symbol closest to the time domain resource of the second resource and located after the time domain resource of the second resource in the time domain as the time domain resource of the available third resource. A number of symbols of the at least one available symbol may be equal to a number of symbols where the first resource overlaps with the second resource.

In an embodiment, the available symbol includes a symbol for transmitting data of the physical uplink shared channel among the time domain resource for transmitting the physical uplink shared channel.

The time domain resource for transmitting the PUSCH includes a resource for transmitting the DMRS of the PUSCH and a resource for transmitting the data of the PUSCH. Assuming that the resource for transmitting the DMRS of the PUSCH is taken as the available third resource, the DMRS originally transmitted on this resource cannot be normally transmitted. Thus, the available symbol needs to be determined from the time domain resource for transmitting the data of the PUSCH.

FIG. 6B is a schematic diagram of another available third resource according to an embodiment of the present disclosure.

As shown in FIG. 6B, based on FIG. 4, a symbol where the first resource overlaps with the second resource is the third symbol. In this case, a number of the overlapping symbols is 1. Thus, three available symbols may be determined.

The time domain resource for transmitting the PUSCH includes the first symbol to the fourteenth symbol, and one available symbol closest to the time domain resource of the second resource and located after the time domain resource of the second resource in the time domain is the fourth symbol. In this case, the terminal may determine that the fourth symbol is the time domain resource of the available third resource. Accordingly, the terminal may transmit the DMRS on the fourth symbol.

In an embodiment, the method further includes: determining a first number of symbols where the first resource overlaps with the second resource and a second number of symbols included in the first resource; determining a ratio of the first number to the second number; and determining from a time domain resource of the first resource, in a case where the ratio is greater than a threshold, at least one available symbol closest to a time domain resource of the second resource and located after the time domain resource of the second resource in a time domain as a time domain resource of the available third resource. The threshold may be indicated by the network device or agreed upon through a protocol.

In an embodiment, in the time domain resource for transmitting the PUSCH, one or more DMRSs may be transmitted. In this case, the first number of symbols where the first resource overlaps with the second resource and the second number of symbols included in the first resource may be determined. Further, the ratio of the first number to the second number may be determined.

In a case where the ratio is greater than the threshold, it indicates that the first resources for relatively more DMRSs overlap with the second resource. Assuming that the terminal transmits no DMRS on the first resources overlapping with the second resource, transmission performance of the PUSCH may be severely affected. Thus, based on the embodiment shown in FIG. 6A, the terminal determines, from the time domain resource of the first resource, the at least one available symbol closest to the time domain resource of the second resource and located after the time domain resource of the second resource in the time domain as the time domain resource of the available third resource, and then transmits the DMRS on the third resource. Accordingly, it may be ensured that a total number of transmitted DMRSs is basically unchanged, and transmission performance of the PUSCH is slightly affected.

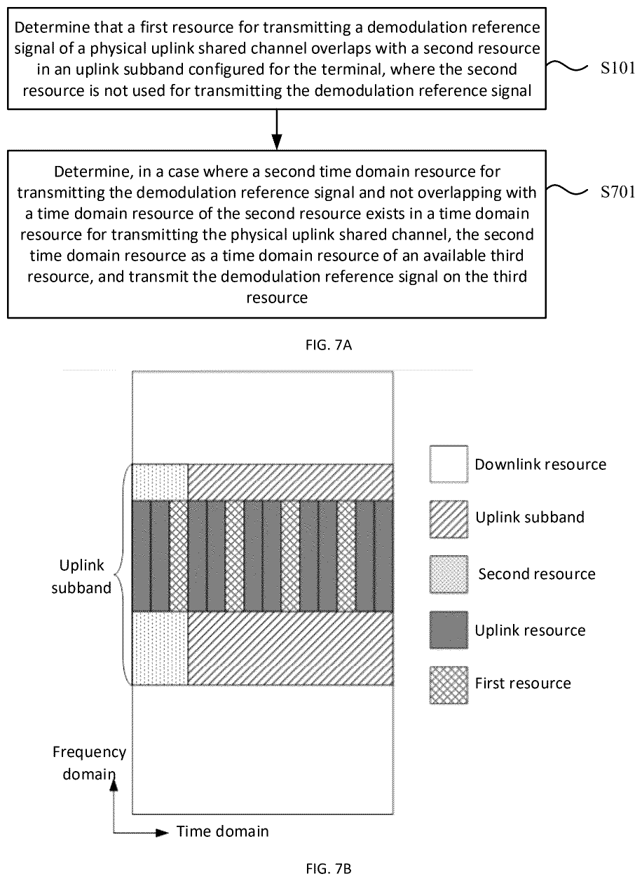

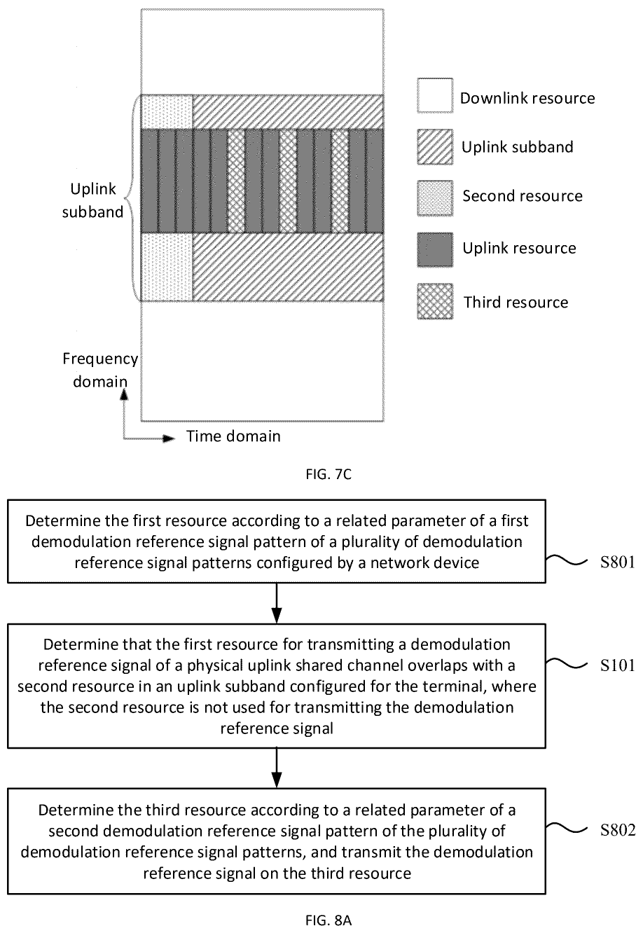

FIG. 7A is a schematic flowchart of yet another method for determining resources according to an embodiment of the present disclosure. As shown in FIG. 7A, determining the available third resource includes step S701, in addition to previously described step S101.

Step S701 includes determining, in a case where a second time domain resource for transmitting the demodulation reference signal and not overlapping with a time domain resource of the second resource exists in a time domain resource for transmitting the physical uplink shared channel, the second time domain resource as a time domain resource of the available third resource.

In an embodiment, one or more DMRSs may be transmitted in the time domain resource for transmitting the PUSCH. Thus, in a case where the second resource overlaps with the first resource for transmitting the DMRS, the second time domain resource for transmitting the PUSCH and not overlapping with the time domain resource of the second resource may still exist in the time domain resource for transmitting the PUSCH. In this case, the terminal may determine the second time domain resource as the third resource, and transmit the PUSCH on the third resource. That is, in the first resource for transmitting the DMRS, resources overlapping with the second resource are not used for transmitting the DMRS, and merely resources not overlapping with the second resource are used for transmitting the DMRS.

FIG. 7B is a schematic diagram showing a relationship between an uplink resource for uplink transmission and the second resource according to an embodiment of the present disclosure.

In an embodiment, one slot may include fourteen symbols. The symbols may be OFDM symbols.

As shown in FIG. 7B, taking the Case a in FIG. 3 as an example, the resource for transmitting the PUSCH corresponds to the entire slot in the time domain, that is, corresponds to the first symbol to the fourteenth symbol, and the second resource corresponds to the first symbol to the third symbol in the time domain. A type of the PUSCH is PUSCH mapping type A. Moreover, the network device indicates an additional demodulation reference signal for the terminal, and Pos in a related parameter of a DMRS pattern configured by a high-layer signaling is Pos3.

Accordingly, as shown in FIG. 7B, the terminal may determine to transmit one DMRS every three symbols. In this case, the DMRS of the PUSCH may be located at a third, a sixth, a ninth, and a twelfth symbol in the slot.

Accordingly, the first resource (that is, the third, the sixth, the ninth and the twelfth symbols) for transmitting the DMRS overlaps with the second resource (that is, the first to the third symbols) on the third symbol. Since the second resource is not used for transmitting the DMRS, the DMRS cannot be normally transmitted on the third symbol.

FIG. 7C is a schematic diagram of yet another available third resource according to an embodiment of the present disclosure.

As shown in FIG. 7C, based on FIG. 7B, the symbol where the first resource overlaps with the second resource is the third symbol. In the time domain resource for transmitting the PUSCH, the second time domain resource for transmitting the DMRS and not overlapping with the time domain resource of the second resource, that is, the sixth, the ninth, and the twelfth symbols, exists. In this case, as shown in FIG. 7C, the terminal may determine the sixth, the ninth, and the twelfth symbols as the third resource, and thus transmits no DMRS at the third symbol, and transmits the DMRS merely at the sixth, the ninth, and the twelfth symbols.

In an embodiment, the method further includes: determining a first number of symbols where the first resource overlaps with the second resource and a second number of symbols included in the first resource; determining a ratio of the first number to the second number; and determining, in a case where the ratio is less than or equal to a threshold and a second time domain resource for transmitting the demodulation reference signal and not overlapping with the time domain resource of the second resource exists in a time domain resource for transmitting the physical uplink shared channel, the second time domain resource as a time domain resource of the available third resource. The threshold may be indicated by the network device or agreed upon through a protocol.

In an embodiment, in the time domain resource for transmitting the PUSCH, one or more DMRSs may be transmitted. In this case, the first number of symbols where the first resource overlaps with the second resource and the second number of symbols included in the first resource may be determined. Further, the ratio of the first number to the second number may be determined.

In a case where the ratio is less than or equal to the threshold, it indicates that the first resources for relatively less DMRSs overlap with the second resource. Assuming that the terminal transmits no DMRS on the first resource overlapping with the second resource, transmission performance of the PUSCH is slightly affected. Thus, based on the embodiment shown in FIG. 7A, the terminal may determine the second time domain resource as the third resource in a case where the second time domain resource for transmitting the DMRS and not overlapping with the time domain resource of the second resource exists in the time domain resource for transmitting the PUSCH. Then, resources overlapping with the second resource are not used for transmitting the DMRS, and merely resources not overlapping with the second resource are used for transmitting the DMRS. Accordingly, although a total number of transmitted DMRSs is reduced, transmission performance of the PUSCH is slightly affected. Moreover, logic for the terminal to transmit the DMRS is simplified.

In an embodiment, the method further includes: determining a first number of symbols where the first resource overlaps with the second resource, and a second number of symbols included in the first resource; determining a ratio of the first number to the second number; determining, in a case where the ratio is less than or equal to a threshold and a second time domain resource for transmitting the demodulation reference signal and not overlapping with the time domain resource of the second resource exists in the time domain resource for transmitting the physical uplink shared channel, the second time domain resource as the third resource; and determining from the time domain resource of the first resource, in a case where the ratio is greater than the threshold, at least one available symbol closest to the time domain resource of the second resource and located after the time domain resource of the second resource in the time domain as the time domain resource of the available third resource.

The threshold may be indicated by the network device or agreed upon through a protocol. For example, the threshold may be ½.

In an embodiment, in the time domain resource for transmitting the PUSCH, one or more DMRSs may be transmitted. In this case, the first number of symbols where the first resource overlaps with the second resource and the second number of symbols included in the first resource may be determined. Further, the ratio of the first number to the second number may be determined.

In a case where the ratio is greater than the threshold, it indicates that the first resources for relatively more DMRSs overlap with the second resource. Assuming that no DMRS is transmitted on the first resource overlapping with the second resource, transmission performance of the PUSCH may be severely affected. Thus, the at least one available symbol closest to the time domain resource of the second resource and located after the time domain resource of the second resource in the time domain may be determined, from the time domain resource of the first resource, as the time domain resource of the available third resource. Then, the DMRS is transmitted on the third resource. Accordingly, it may be ensured that a total number of transmitted DMRSs is basically unchanged, and transmission performance of the PUSCH is slightly affected.

In a case where the ratio is less than or equal to the threshold, it indicates that the first resources for relatively less DMRSs overlap with the second resource. Assuming that no DMRS is transmitted on the first resource overlapping with the second resource, transmission performance of the PUSCH is slightly affected. Thus, the second time domain resource may be determined as the third resource in a case where the second time domain resource for transmitting the DMRS and not overlapping with the time domain resource of the second resource exists in the time domain resource for transmitting the PUSCH. Then, resources overlapping with the second resource are not used for transmitting the DMRS, and merely resources not overlapping with the second resource are used for transmitting the DMRS. Accordingly, although a total number of transmitted DMRSs is reduced, transmission performance of the PUSCH is slightly affected. Moreover, logic for the terminal to transmit the DMRS is simplified.

FIG. 8A is a schematic flowchart of still another method for determining resources according to an embodiment of the present disclosure. As shown in FIG. 8A, the method further includes step S801, and S802, in addition to previously described step S101.

Step S801 includes determining the first resource according to a related parameter of a first demodulation reference signal pattern of a plurality of demodulation reference signal patterns configured by the network device.

Determining the available third resource includes step S802.

Step S802 includes determining the third resource according to a related parameter of a second demodulation reference signal pattern of the plurality of demodulation reference signal patterns.

The related parameter of the first DMRS pattern may be referred to as a related parameter of a predetermined DMRS pattern. The related parameter of the second DMRS pattern may be referred to as a related parameter of an optional DMRS pattern.

In an embodiment, the network device may configure related parameters of a plurality of DMRS patterns for the terminal. The terminal may select a related parameter of one DMRS pattern to determine a resource for transmitting the DMRS. For example, the terminal may determine a resource for transmitting the DMRS as the first resource according to the related parameter of the first DMRS pattern, and the first resource overlaps with the second resource.

In this case, the terminal may select, from the related parameters of the plurality of DMRS patterns, the related parameter of the second DMRS pattern other than the related parameter of the first DMRS pattern to determine a resource for transmitting the DMRS as the third resource. The determined third resource may not overlap with the second resource. No collision with the second resource exists for transmitting the DMRS on the third resource, and normal transmission of the DMRS may be ensured.

In an embodiment, a related parameter of each DMRS pattern may be associated with a priority. The terminal may select the related parameters of the DMRS patterns one by one according to priorities from high to low to determine the resource for transmitting the DMRS.

For example, in a case where the terminal selects related parameters of other DMRS patterns other than the related parameter of the first DMRS pattern, a related parameter of one DMRS pattern may be first selected according to priorities from high to low to determine the resource for transmitting the DMRS. In a case where the determined resource for transmitting the DMRS still overlaps with the second resource, a related parameter of another DMRS pattern may be selected according to priorities from high to low to determine the resource for transmitting the DMRS until the determined resource for transmitting the DMRS does not overlap with the second resource. Then, the determined resource for transmitting the DMRS may be taken as the third resource.

FIG. 8B is a schematic diagram of still another available third resource according to an embodiment of the present disclosure.

As shown in FIG. 8B, based on FIG. 4, the first resource for transmitting the DMRS determined by the terminal according to the first DMRS pattern overlaps with the second resource on the third symbol. Then, the terminal may select the second DMRS pattern to determine the third resource for transmitting the DMRS. For example, the resource for transmitting the DMRS determined according to the second DMRS pattern may be the sixth symbol which does not overlap with the second resource. Thus, it may be determined that the sixth symbol is the time domain resource of the available third resource. Accordingly, the DMRS is transmitted on the sixth symbol.

It needs to be noted that the embodiments of the present disclosure may be suitable for transmission of any type of PUSCHs. In an embodiment, a type of the physical uplink shared channel includes at least one of: PUSCH mapping type A; or PUSCH mapping type B.

It needs to be noted that the embodiments of the present disclosure may be suitable for related parameters of any DMRS patterns. In an embodiment, the related parameter of the demodulation reference signal pattern includes at least one of: a single DMRS, a double DMRS, an additional DMRS, intra-slot frequency hopping (FH) enabled, or intra-slot FH disabled.

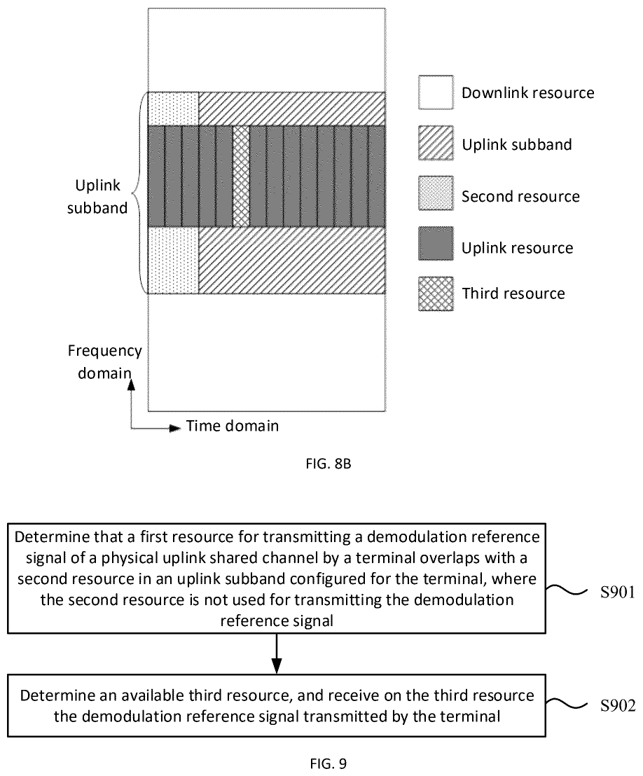

FIG. 9 is a schematic flowchart of a method for determining resources according to an embodiment of the present disclosure. The method for determining resources may be performed by a network device. The network device may be in communication with a terminal. The network device includes but is not limited to a base station in a communication system, such as a 4G base station, a 5G base station and a 6G base station. The terminal includes but is not limited to a communication device such as a mobile phone, a tablet computer, a wearable device, a sensor, and an internet of things device.

As shown in FIG. 9, the method for determining resources may include steps S901 and S902.

Step S901 includes determining that a first resource for transmitting a demodulation reference signal of a physical uplink shared channel by a terminal overlaps with a second resource in an uplink subband configured for the terminal, where the second resource is not used for transmitting the demodulation reference signal.

Step S902 includes determining an available third resource, and receiving on the third resource the demodulation reference signal transmitted by the terminal.

In an embodiment, taking the Case a in FIG. 3 as an example, the resource for transmitting the PUSCH corresponds to the entire slot in the time domain, that is, corresponds to the first symbol to the fourteenth symbol, and the second resource corresponds to the first symbol to the third symbol in the time domain. A type of the PUSCH is PUSCH mapping type A, and the network device does not indicate an additional DMRS for the terminal. In this case, the DMRS of the PUSCH may be located at the second or the third symbol in the slot.

For example, as shown in FIG. 4, taking the DMRS being located at the third symbol in the slot as an example, the first resource (that is, the third symbol) for transmitting the DMRS overlaps with the second resource (that is, the first symbol to the third symbol) on the third symbol. Since the second resource is not used for transmitting the DMRS, the DMRS cannot be normally transmitted on the third symbol. However, the DMRS is used for a demodulation related operation for the PUSCH. Accordingly, transmission performance of the PUSCH is degraded.

According to the embodiment, in a case where it is determined that, in the uplink subband, the first resource for transmitting the DMRS of the PUSCH by the terminal overlaps with the second resource not used for transmitting the DMRS, the network device may determine the available third resource. For example, the third resource may be a resource in the uplink subband that does not overlap with the second resource. Then, the DMRS transmitted by the terminal may be received on the third resource. Thus, normal reception of the DMRS may be ensured, and desirable transmission performance of the PUSCH may be ensured.

In an embodiment, the second resource includes a rate matching resource (RMR), that is, a resource for rate matching.

In an embodiment, a terminal for which an uplink subband is configured in a downlink slot may perform uplink transmission in the uplink subband of the downlink slot. This terminal may be referred to as a subband full duplex (SBFD) terminal. A terminal for which no uplink subband is configured in a downlink slot may receive merely downlink transmission in the downlink slot. This terminal may be referred to as a legacy terminal.

The network device may schedule downlink transmission of the legacy terminal in the downlink slot. The downlink transmission includes but is not limited to a semi-static PDSCH, a dynamic PDSCH, a PDCCH, a CSI-RS, a PRS, etc.

In a case where the downlink transmission overlaps with the uplink subband, the uplink transmission of the SBFD terminal in the uplink subband may be interfered. In order to resolve this problem, the network device may configure a rate matching resource for the SBFD terminal in the uplink subband, and the SBFD terminal may perform rate matching according to the rate matching resource. Thus, collision between the downlink transmission and the uplink subband may be avoided. In the rate matching resource, the SBFD terminal cannot transmit the DMRS. Thus, the second resource may include the rate matching resource.

In an embodiment, determining the available third resource includes: determining, from a time domain resource for the terminal to transmit the physical uplink shared channel, a first time domain resource not overlapping with a time domain resource of the second resource; and determining a time domain resource of the available third resource from the first time domain resource according to a related parameter of a demodulation reference signal pattern configured for the terminal.

In an embodiment, the time domain resource for transmitting the PUSCH may include the first time domain resource not overlapping with the time domain resource of the second resource. In this case, the network device may determine the available third resource from the first time domain resource according to the related parameter of the demodulation reference signal pattern configured by the network device.

For example, as shown in FIG. 5B, based on FIG. 4, the time domain resource for transmitting the PUSCH includes the first symbol to the fourteenth symbol, and the fourth symbol to the fourteenth symbol do not overlap with the second resource. In this case, the network device may determine the available third resource from the fourth to fourteenth symbols according to the related parameter of the DMRS pattern configured by the network device. For example, the related parameter of the DMRS pattern include a demodulation reference signal type A position, that is, DMRS-TypeA-Position. It may be determined according to this related parameter that a sixth symbol is the time domain resource of the available third resource. Accordingly, the DMRS transmitted by the terminal may be received on the sixth symbol.

In an embodiment, determining the available third resource includes: determining, from a time domain resource for the terminal to transmit the physical uplink shared channel, at least one available symbol closest to a time domain resource of the second resource and located after the time domain resource of the second resource in the time domain as a time domain resource of the available third resource.

In an embodiment, the network device may determine, from the time domain resource for the terminal to transmit the PUSCH, at least one available symbol closest to the time domain resource of the second resource and located after the time domain resource of the second resource in the time domain as the time domain resource of the available third resource. A number of symbols of the at least one available symbol may be equal to a number of symbols where the first resource overlaps with the second resource.

In an embodiment, the available symbol includes a symbol for transmitting data of the physical uplink shared channel among the time domain resource for transmitting the physical uplink shared channel.

The time domain resource for transmitting the PUSCH includes a resource for transmitting the DMRS of the PUSCH and a resource for transmitting the data of the PUSCH. Assuming that the resource for transmitting the DMRS of the PUSCH is taken as the available third resource, the DMRS originally transmitted on this resource cannot be normally transmitted. Thus, the available symbol needs to be determined from the time domain resource for transmitting the data of the PUSCH.

As shown in FIG. 6B, based on FIG. 4, a symbol where the first resource overlaps with the second resource is the third symbol. In this case, a number of the overlapping symbols is 1. Thus, three available symbols may be determined.

The time domain resource for transmitting the PUSCH includes the first symbol to the fourteenth symbol, and one available symbol closest to the time domain resource of the second resource and located after the time domain resource of the second resource in the time domain is the fourth symbol. In this case, the network device may determine that the fourth symbol is the time domain resource of the available third resource. Accordingly, the network device may receive on the fourth symbol the DMRS transmitted by the terminal.

In an embodiment, the method further includes: determining a first number of symbols where the first resource overlaps with the second resource and a second number of symbols included in the first resource; determining a ratio of the first number to the second number; and determining from a time domain resource of the first resource, in a case where the ratio is greater than a threshold, at least one available symbol closest to a time domain resource of the second resource and located after the time domain resource of the second resource in a time domain as a time domain resource of the available third resource.

In an embodiment, in the time domain resource for transmitting the PUSCH, one or more DMRSs may be transmitted. In this case, the first number of symbols where the first resource overlaps with the second resource and the second number of symbols included in the first resource may be determined. Further, the ratio of the first number to the second number may be determined.

In a case where the ratio is greater than the threshold, it indicates that the first resources for relatively more DMRSs overlap with the second resource. Assuming that the network device does not receive the DMRS transmitted by the terminal on the first resources overlapping with the second resource, transmission performance of the PUSCH may be severely affected. Thus, the network device may determine, from the time domain resource of the first resource, the at least one available symbol closest to the time domain resource of the second resource and located after the time domain resource of the second resource in the time domain as the time domain resource of the available third resource, and then receive on the third resource the DMRS transmitted by the terminal. Accordingly, it may be ensured that a total number of received DMRSs is basically unchanged, and transmission performance of the PUSCH is slightly affected.

In an embodiment, determining the available third resource includes: determining, in a case where a second time domain resource for transmitting the demodulation reference signal and not overlapping with a time domain resource of the second resource exists in a time domain resource for the terminal to transmit the physical uplink shared channel, the second time domain resource as a time domain resource of the available third resource.

In an embodiment, in the time domain resource for transmitting the PUSCH, one or more DMRSs may be transmitted. In this case, the first number of symbols where the first resource overlaps with the second resource and the second number of symbols included in the first resource may be determined. Further, the ratio of the first number to the second number is determined.

In a case where the ratio is greater than the threshold, it indicates that the first resources for relatively more DMRSs overlap with the second resource. Assuming that the terminal transmits no DMRS on the first resources overlapping with the second resource, transmission performance of the PUSCH may be severely affected. Thus, based on the embodiment shown in FIG. 6A, the terminal determines, from the time domain resource of the first resource, the at least one available symbol closest to the time domain resource of the second resource and located after the time domain resource of the second resource in the time domain as the time domain resource of the available third resource, and then transmits the DMRS on the third resource. Accordingly, it may be ensured that a total number of transmitted DMRSs is basically unchanged, and transmission performance of the PUSCH is slightly affected.

In an embodiment, determining the available third resource includes: determining, in a case where a second time domain resource for transmitting the demodulation reference signal and not overlapping with a time domain resource of the second resource exists in a time domain resource for transmitting the physical uplink shared channel, the second time domain resource as a time domain resource of the available third resource.

In an embodiment, one or more DMRSs may be transmitted in the time domain resource for transmitting the PUSCH. Thus, in a case where the second resource overlaps with the first resource for transmitting the DMRS, the second time domain resource for transmitting the PUSCH and not overlapping with the time domain resource of the second resource may still exist in the time domain resource for transmitting the PUSCH. In this case, the network device may determine the second time domain resource as the third resource, and receive on the third resource the PUSCH transmitted by the terminal. That is, in the first resource for transmitting the DMRS, resources overlapping with the second resource are not used for receiving the DMRS transmitted by the terminal, and merely resources not overlapping with the second resource are used for receiving the DMRS transmitted by the terminal.

In an embodiment, one slot may include fourteen symbols. The symbols may be OFDM symbols.

As shown in FIG. 7B, taking the Case a in FIG. 3 as an example, the resource for transmitting the PUSCH corresponds to the entire slot in the time domain, that is, corresponds to the first symbol to the fourteenth symbol, and the second resource corresponds to the first symbol to the third symbol in the time domain. A type of the PUSCH is PUSCH mapping type A. Moreover, the network device indicates an additional demodulation reference signal for the terminal, and Pos in a related parameter of a DMRS pattern configured by a high-layer signaling is Pos3.

Accordingly, as shown in FIG. 7B, the network device may determine that the terminal transmits one DMRS every three symbols. In this case, the DMRS of the PUSCH may be located at a third, a sixth, a ninth, and a twelfth symbol in the slot.

Accordingly, the first resource (that is, the third, the sixth, the ninth and the twelfth symbols) for transmitting the DMRS overlaps with the second resource (that is, the first to the third symbols) on the third symbol. Since the second resource is not used for transmitting the DMRS, the DMRS cannot be normally transmitted on the third symbol.

As shown in FIG. 7C, based on FIG. 7B, the symbol where the first resource overlaps with the second resource is the third symbol. In the time domain resource for transmitting the PUSCH, the second time domain resource for transmitting the DMRS and not overlapping with the time domain resource of the second resource, that is, the sixth, the ninth, and the twelfth symbols, exists. In this case, as shown in FIG. 7C, the network device may determine the sixth, the ninth, and the twelfth symbols as the third resources, and thus does not receive on the third symbol the DMRS transmitted by the terminal, and receives, merely at the sixth, the ninth, and the twelfth symbols, the DMRS transmitted by the terminal.

In an embodiment, the method further includes: determining a first number of symbols where the first resource overlaps with the second resource and a second number of symbols included in the first resource; determining a ratio of the first number to the second number; and determining, in a case where the ratio is less than or equal to a threshold and a second time domain resource for transmitting the demodulation reference signal and not overlapping with a time domain resource of the second resource exists in a time domain resource for the terminal to transmit the physical uplink shared channel, the second time domain resource as a time domain resource of the available third resource.

In an embodiment, in the time domain resource for transmitting the PUSCH, one or more DMRSs may be transmitted. In this case, the first number of symbols where the first resource overlaps with the second resource and the second number of symbols included in the first resource may be determined. Further, the ratio of the first number to the second number is determined.

In a case where the ratio is less than or equal to the threshold, it indicates that the first resources for relatively less DMRSs overlap with the second resource. Assuming that no DMRS is transmitted on the first resources overlapping with the second resource, transmission performance of the PUSCH is slightly affected. Thus, the network device may determine the second time domain resource as the third resource in a case where the second time domain resource for transmitting the DMRS and not overlapping with the time domain resource of the second resource exists in the time domain resource for transmitting the PUSCH. Then, resources overlapping with the second resource are not used for receiving the DMRS transmitted by the terminal, and merely resources not overlapping with the second resource are used for receiving the DMRS transmitted by the terminal. Accordingly, although a total number of transmitted DMRSs is reduced, transmission performance of the PUSCH is slightly affected. Moreover, logic for the terminal to transmit the DMRS may be simplified.

In an embodiment, the method further includes: determining the first resource according to a related parameter of a first demodulation reference signal pattern of a plurality of demodulation reference signal patterns configured for the terminal.

Further, determining the available third resource includes: determining the third resource according to a related parameter of a second demodulation reference signal pattern of the plurality of demodulation reference signal patterns.

The related parameter of the first DMRS pattern may be referred to as a related parameter of a predetermined DMRS pattern. The related parameter of the second DMRS pattern may be referred to as a related parameter of an optional DMRS pattern.

In an embodiment, the network device may configure related parameters of a plurality of DMRS patterns for the terminal. The network device may select a related parameter of one DMRS pattern to determine a resource for transmitting the DMRS. For example, the network device may determine a resource for transmitting the DMRS as the first resource according to the related parameter of the first DMRS pattern, and the first resource overlaps with the second resource.

In this case, the network device may select, from the related parameters of the plurality of DMRS patterns, the related parameter of the second DMRS pattern other than the related parameter of the first DMRS pattern to determine a resource for transmitting the DMRS as the third resource. The determined third resource may not overlap with the second resource. No collision with the second resource exists for transmitting the DMRS on the third resource, and normal transmission of the DMRS may be ensured.

In an embodiment, a related parameter of each DMRS pattern may be associated with a priority. The network device may select the related parameters of the DMRS patterns one by one according to priorities to determine the resource for transmitting the DMRS.

For example, in a case where the network device selects related parameters of other DMRS patterns other than the related parameter of the first DMRS pattern, a related parameter of one DMRS pattern may be first selected according to priorities from high to low to determine the resource for transmitting the DMRS. In a case where the determined resource for transmitting the DMRS still overlaps with the second resource, a related parameter of another DMRS pattern may be selected according to priorities from high to low to determine the resource for transmitting the DMRS until the determined resource for transmitting the DMRS does not overlap with the second resource. Then, the determined resource for transmitting the DMRS may be taken as the third resource.

As shown in FIG. 8B, based on FIG. 4, the first resource for transmitting the DMRS determined by the network device according to the first DMRS pattern overlaps with the second resource on the third symbol. Then, the network device may select the second DMRS pattern to determine the third resource for transmitting the DMRS. For example, the resource for transmitting the DMRS determined according to the second DMRS pattern may be the sixth symbol which does not overlap with the second resource. Thus, it may be determined that the sixth symbol is the time domain resource of the available third resource. Accordingly, the DMRS transmitted by the terminal is received on the sixth symbol.

It needs to be noted that the embodiments of the present disclosure may be suitable for transmission of any type of PUSCHs. In an embodiment, a type of the physical uplink shared channel includes at least one of: PUSCH mapping type A; or PUSCH mapping type B.

It needs to be noted that the embodiments of the present disclosure may be suitable for related parameters of any DMRS patterns. In an embodiment, the related parameter of the demodulation reference signal pattern includes at least one of: a single DMRS, a double DMRS, an additional DMRS, intra-slot FH enabled, or intra-slot FH disabled.

Corresponding to the embodiments of the method for determining resources, the present disclosure further provides embodiments of a device for determining resources.

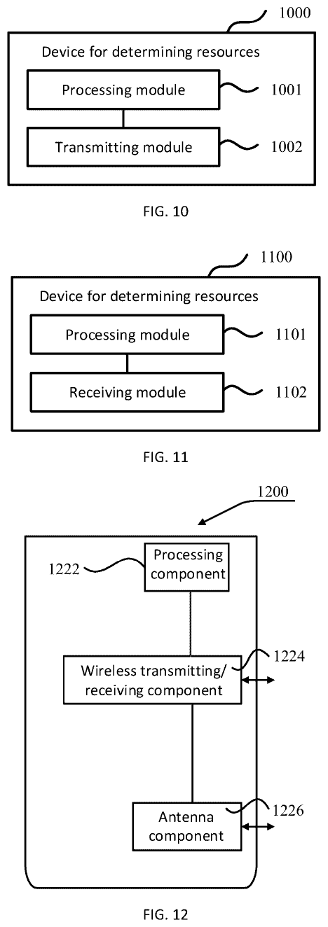

FIG. 10 is a schematic block diagram of a device for determining resources according to an embodiment of the present disclosure. The device is configured in a terminal. As shown in FIG. 10, the device for determining resources 1000 includes a processing module 1001 and a transmitting module 1002.

The processing module 1001 is configured to determine that a first resource for transmitting a demodulation reference signal of a physical uplink shared channel overlaps with a second resource in an uplink subband configured for the terminal and to determine an available third resource, where the second resource is not used for transmitting the demodulation reference signal.

The transmitting module 1002 is configured to transmit the demodulation reference signal on the third resource.

In an embodiment, the processing module 1001 is configured to determine, from a time domain resource for transmitting the physical uplink shared channel, a first time domain resource not overlapping with a time domain resource of the second resource; and determine a time domain resource of the available third resource from the first time domain resource according to a related parameter of a demodulation reference signal pattern configured by a network device.

In an embodiment, the processing module 1001 is configured to determine, from a time domain resource for transmitting the physical uplink shared channel, at least one available symbol closest to a time domain resource of the second resource and located after the time domain resource of the second resource in a time domain as a time domain resource of the available third resource.

In an embodiment, the available symbol includes a symbol for transmitting data of the physical uplink shared channel among the time domain resource for transmitting the physical uplink shared channel.

In an embodiment, the processing module 1001 is configured to determine a first number of symbols where the first resource overlaps with the second resource and a second number of symbols included in the first resource; and determine a ratio of the first number to the second number. The processing module 1001 is configured to determine from a time domain resource of the first resource, in a case where the ratio is greater than a threshold, at least one available symbol closest to a time domain resource of the second resource and located after the time domain resource of the second resource in a time domain as a time domain resource of the available third resource.

In an embodiment, the processing module 1001 is configured to determine, in a case where a second time domain resource for transmitting the demodulation reference signal and not overlapping with a time domain resource of the second resource exists in a time domain resource for transmitting the physical uplink shared channel, the second time domain resource as a time domain resource of the available third resource.

In an embodiment, the processing module 1001 is configured to determine a first number of symbols where the first resource overlaps with the second resource and a second number of symbols included in the first resource; and determine a ratio of the first number to the second number. The processing module 1001 is configured to determine, in a case where the ratio is less than or equal to a threshold and a second time domain resource for transmitting the demodulation reference signal and not overlapping with a time domain resource of the second resource exists in a time domain resource for transmitting the physical uplink shared channel, the second time domain resource as a time domain resource of the available third resource.

In an embodiment, the processing module 1001 is configured to determine the first resource according to a related parameter of a first demodulation reference signal pattern of a plurality of demodulation reference signal patterns configured by a network device. The processing module 1001 is configured to determine the third resource according to a related parameter of a second demodulation reference signal pattern of the plurality of demodulation reference signal patterns.

In an embodiment, the second resource includes a rate matching resource.

FIG. 11 is a schematic block diagram of a device for determining resources according to an embodiment of the present disclosure. The device is configured in a network device. As shown in FIG. 11, the device for determining resources 1100 includes a processing module 1101 and a receiving module 1102.

The processing module 1101 is configured to determine that a first resource for transmitting a demodulation reference signal of a physical uplink shared channel by a terminal overlaps with a second resource in an uplink subband configured for the terminal and to determine an available third resource, where the second resource is not used for transmitting the demodulation reference signal.

The receiving module 1102 is configured to receive on the third resource the demodulation reference signal transmitted by the terminal.

In an embodiment, the processing module 1101 is configured to determine, from a time domain resource for the terminal to transmit the physical uplink shared channel, a first time domain resource not overlapping with a time domain resource of the second resource; and determine a time domain resource of the available third resource from the first time domain resource according to a related parameter of a demodulation reference signal pattern configured for the terminal.

In an embodiment, the processing module 1101 is configured to determine, from a time domain resource for the terminal to transmit the physical uplink shared channel, at least one available symbol closest to a time domain resource of the second resource and located after the time domain resource of the second resource in a time domain as a time domain resource of the available third resource.

In an embodiment, the available symbol includes a symbol for transmitting data of the physical uplink shared channel among the time domain resource for transmitting the physical uplink shared channel.

In an embodiment, the processing module 1101 is configured to determine a first number of symbols where the first resource overlaps with the second resource and a second number of symbols included in the first resource; and determine a ratio of the first number to the second number. The processing module 1101 is configured to determine from a time domain resource of the first resource, in a case where the ratio is greater than a threshold, at least one available symbol closest to a time domain resource of the second resource and located after the time domain resource of the second resource in a time domain as a time domain resource of the available third resource.

In an embodiment, the processing module 1101 is configured to determine, in a case where a second time domain resource for transmitting the demodulation reference signal and not overlapping with a time domain resource of the second resource exists in a time domain resource for the terminal to transmit the physical uplink shared channel, the second time domain resource as a time domain resource of the available third resource.

In an embodiment, the processing module 1101 is configured to determine a first number of symbols where the first resource overlaps with the second resource and a second number of symbols included in the first resource; and determine a ratio of the first number to the second number. The processing module 1101 is configured to determine, in a case where the ratio is less than or equal to a threshold and a second time domain resource for transmitting the demodulation reference signal and not overlapping with a time domain resource of the second resource exists in a time domain resource for the terminal to transmit the physical uplink shared channel, the second time domain resource as a time domain resource of the available third resource.

In an embodiment, the processing module 1101 is configured to determine the first resource according to a related parameter of a first demodulation reference signal pattern of a plurality of demodulation reference signal patterns configured for the terminal. The processing module 1101 is configured to determine the third resource according to a related parameter of a second demodulation reference signal pattern of the plurality of demodulation reference signal patterns.

In an embodiment, the second resource includes a rate matching resource.

Since device embodiments substantially correspond to method embodiments, reference may be made to portions of the descriptions of the method embodiments for related content. The device embodiments described are merely schematic, modules described as separate components may be physically separated or not, and components displayed as modules may be physical units or not. That is, the components may be located at one place, or distributed at a plurality of network modules. Some or all of modules may be selected according to actual requirements to achieve the objective of the solution of the embodiment. A person of ordinary skill in the art may understand and implement the present disclosure without making creative efforts.

An embodiment of the present disclosure further provides a system for determining resources (not shown). The system for determining resources includes a terminal and a network device. The terminal is configured to implement the method for determining resources performed by the terminal in any one of the method embodiments. The network device is configured to implement the method for determining resources performed by the network device in any one of the method embodiments.

An embodiment of the present disclosure further provides a communication device (not shown). The communication device includes: one or more processors; and a memory configured to store a computer program. The computer program, when executed by the one or more processors, implements the method for determining resources performed by the terminal in any one of the embodiments.

An embodiment of the present disclosure further provides a communication device (not shown). The communication device includes: one or more processors; and a memory configured to store a computer program, where the computer program, when executed by the one or more processors, implements the method for determining resources performed by the network device in any one of the embodiments.

An embodiment of the present disclosure further provides a non-transitory computer-readable storage medium. The non-transitory computer-readable storage medium is used for storing a computer program, where the computer program, when executed by one or more processors, implements the method for determining resources performed by the terminal in any one of the embodiments.

An embodiment of the present disclosure further provides a non-transitory computer-readable storage medium. The non-transitory computer-readable storage medium is used for storing a computer program, where the computer program, when executed by one or more processors, implements the method for determining resources performed by the network device in any one of the embodiments.

As shown in FIG. 12, a schematic block diagram of a device for determining resources 1200 according to an embodiment of the present disclosure is shown in FIG. 12. The device 1200 may be a base station. With reference to FIG. 12, the device 1200 includes a processing component 1222, a wireless transmitting/receiving component 1224, an antenna component 1226, and a signal processing portion (not shown) specific to a wireless interface. The processing component 1222 may further include one or more processors (not shown). One of the processors of the processing component 1222 may be configured to implement the method for determining resources performed by the network device in any one of the embodiments.

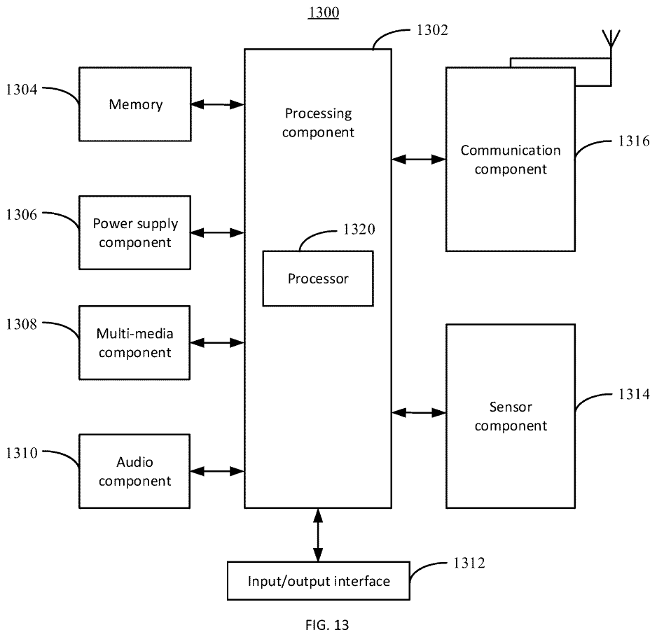

FIG. 13 is a schematic block diagram of a device for determining resources 1300 according to an embodiment of the present disclosure. For example, the device 1300 may be a terminal, such as a mobile phone, a computer, a digital broadcasting terminal, a message receiving and transmitting device, a game console, a tablet device, a medical device, a fitness device, and a personal digital assistant.

With reference to FIG. 13, the device 1300 may include one or more of components as follows: a processing component 1302, a memory 1304, a power supply component 1306, a multi-media component 1308, an audio component 1310, an input/output (I/O) interface 1312, a sensor component 1314, and a communication component 1316.

The processing component 1302 generally controls overall operations of the device 1300, such as operations associated with display, telephone call, data communication, camera operations, and recording operations. The processing component 1302 may include one or more processors 1320 to execute instructions, so as to perform all or some steps of the method for determining resources performed by the terminal in any one of the embodiments. In addition, the processing component 1302 may include one or more modules such that the processing component 1302 may interact with other components. For example, the processing component 1302 may include a multi-media module (not shown) such that the multi-media component 1308 may interact with the processing component 1302.

The memory 1304 is configured to store various types of data to support operations at the device 1300. Examples of such data include instructions configured for any applications or methods operating on the device 1300, such as contact data, phonebook data, messages, pictures and video.

The power supply component 1306 provides power for various components of the device 1300. The power supply component 1306 may include a power supply management system, one or more power supplies, and other components associated with generation, management and power distribution of the device 1300.

The multi-media component 1308 includes a screen that provides an output interface between the device 1300 and a user. In some embodiments, the screen may include a liquid crystal display (LCD) and a touch panel (TP). In a case where the screen includes a touch panel, the screen may be implemented as a touch screen to receive an input signal from a user.

The audio component 1310 is configured to output and/or input an audio signal. For example, the audio component 1310 includes a microphone (MIC). When the device 1300 is in an operating mode, such as a call mode, a recording mode, or a voice recognition mode, the microphone is configured to receive an external audio signal. The received audio signal may be further stored in the memory 1304 or transmitted via the communication component 1316. In some embodiments, the audio component 1310 further includes a loudspeaker configured to output an audio signal.

The I/O interface 1312 provides an interface between the processing component 1302 and peripheral interface modules, such as keyboards, click wheels and buttons. These buttons may include but are not limited to a home button, a volume button, a start button and a lock button.

The sensor component 1314 includes one or more sensors configured to provide state assessment of various aspects for the device 1300.

The communication component 1316 is configured to facilitate wired or wireless communication between the device 1300 and other devices. The device 1300 may access a wireless network based on a communication standard, such as Wi-Fi, 2G, 3G, 4G long term evolution (LTE), 5G new radio (NR) or their combinations. In an example, the communication component 1316 receives a broadcast signal or broadcast related information from an external broadcast management system through a broadcast channel. In an example, the communication component 1316 further includes a near-field communication (NFC) module to promote short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 1300 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements, and is used for performing the method for determining resources performed by the terminal in any one of the embodiments.

In an example, a non-transitory computer-readable storage medium including instructions is further provided, such as the memory 1304 including instructions. The instructions may be executed by the processor 1320 of the device 1300, so as to complete the method for determining resources performed by the terminal in any one of the embodiments. For example, the non-transitory computer-readable storage medium may be a read-only memory (ROM), a random access memory (RAM), a compact disc read-only memory (CD-ROM), a magnetic tape, a floppy disk, an optical data storage device, etc.

As used herein, the term “processor” may refer to one processor that performs the defined functions or a plurality of processors that collectively perform defined functions, such that the execution of the individual defined functions may be divided amongst such processors.

A person skilled in the art could easily conceive of other implementation solutions of the present disclosure upon consideration of the description and the present disclosure disclosed in the implementations. The present disclosure is intended to encompass any variations, uses or adaptive changes of the present disclosure. These variations, uses or adaptive changes follow the general principles of the present disclosure and include common general knowledge or customary technical means, which is not disclosed in the present disclosure. The description and embodiments are regarded as exemplary merely. The true scope and spirit of the present disclosure are indicated by the following claims.

It is to be understood that the present disclosure is not limited to a precise structure described in the present disclosure and shown in accompanying drawings, and may have various modifications and changes without departing from the scope of the present disclosure. The scope of the present disclosure is limited by the appended claims merely.

1. A method for determining resources, performed by a terminal, the method comprising:
determining that a first resource for transmitting a demodulation reference signal of a physical uplink shared channel overlaps with a second resource in an uplink subband configured for the terminal, wherein the second resource is not used for transmitting the demodulation reference signal; and
determining an available third resource, and transmitting the demodulation reference signal on the available third resource.

2. The method according to claim 1, wherein determining the available third resource comprises:
determining, from a time domain resource for transmitting the physical uplink shared channel, a first time domain resource not overlapping with a time domain resource of the second resource; and
determining a time domain resource of the available third resource from the first time domain resource according to a related parameter of a demodulation reference signal pattern configured by a network device.

3. The method according to claim 1, wherein determining the available third resource comprises:
determining, from a time domain resource for transmitting the physical uplink shared channel, at least one available symbol closest to a time domain resource of the second resource and located after the time domain resource of the second resource in a time domain as a time domain resource of the available third resource.

4. The method according to claim 3, wherein the at least one available symbol comprises a symbol for transmitting data of the physical uplink shared channel among the time domain resource for transmitting the physical uplink shared channel.

5. The method according to claim 3, further comprising:
determining a first number of symbols, where the first resource overlaps with the second resource, and a second number of symbols comprised in the first resource;
determining a ratio of the first number of symbols to the second number of symbols; and
determining from a time domain resource of the first resource, in a case where the ratio is greater than a threshold, the at least one available symbol closest to the time domain resource of the second resource and located after the time domain resource of the second resource in the time domain as the time domain resource of the available third resource.

6. The method according to claim 1, wherein determining the available third resource comprises:
determining, in a case where a second time domain resource for transmitting the demodulation reference signal and not overlapping with a time domain resource of the second resource exists in a time domain resource for transmitting the physical uplink shared channel, the second time domain resource as a time domain resource of the available third resource.

7. The method according to claim 6, the method further comprising:
determining a first number of symbols where the first resource overlaps with the second resource, and a second number of symbols comprised in the first resource;
determining a ratio of the first number of symbols to the second number of symbols; and
determining, in a case where the ratio is less than or equal to a threshold and the second time domain resource for transmitting the demodulation reference signal and not overlapping with the time domain resource of the second resource exists in the time domain resource for transmitting the physical uplink shared channel, the second time domain resource as the time domain resource of the available third resource.

8. The method according to claim 1, further comprising:
determining the first resource according to a related parameter of a first demodulation reference signal pattern of a plurality of demodulation reference signal patterns configured by a network device, and
wherein determining the available third resource comprises:
determining the available third resource according to a related parameter of a second demodulation reference signal pattern of the plurality of demodulation reference signal patterns.

9. The method according to claim 1, wherein the second resource comprises a rate matching resource.

10. A method for determining resources, performed by a network device, the method comprising:
determining that a first resource for transmitting a demodulation reference signal of a physical uplink shared channel by a terminal overlaps with a second resource in an uplink subband configured for the terminal, wherein the second resource is not used for transmitting the demodulation reference signal; and
determining an available third resource, and receiving, on the available third resource, the demodulation reference signal transmitted by the terminal.

11. The method according to claim 10, wherein determining the available third resource comprises:
determining, from a time domain resource for the terminal to transmit the physical uplink shared channel, a first time domain resource not overlapping with a time domain resource of the second resource; and
determining a time domain resource of the available third resource from the first time domain resource according to a related parameter of a demodulation reference signal pattern configured for the terminal.

12. The method according to claim 10, wherein determining the available third resource comprises:
determining, from a time domain resource for the terminal to transmit the physical uplink shared channel, at least one available symbol closest to a time domain resource of the second resource and located after the time domain resource of the second resource in a time domain as a time domain resource of the available third resource.

13. The method according to claim 12, wherein the at least one available symbol comprises a symbol for transmitting data of the physical uplink shared channel among the time domain resource for transmitting the physical uplink shared channel.

14. The method according to claim 12, further comprising:
determining a first number of symbols, where the first resource overlaps with the second resource, and a second number of symbols comprised in the first resource;
determining a ratio of the first number of symbols to the second number of symbols; and
determining, in a case where the ratio is greater than a threshold, the at least one available symbol closest to the time domain resource of the second resource and located after the time domain resource of the second resource in the time domain from the time domain resource of the first resource as the time domain resource of the available third resource.

15. The method according to claim 10, wherein determining the available third resource comprises:
determining, in a case where a second time domain resource for transmitting the demodulation reference signal and not overlapping with a time domain resource of the second resource exists in a time domain resource for the terminal to transmit the physical uplink shared channel, the second time domain resource as a time domain resource of the available third resource.

16. The method according to claim 15, further comprising:
determining a first number of symbols, where the first resource overlaps with the second resource, and a second number of symbols comprised in the first resource;
determining a ratio of the first number of symbols to the second number of symbols; and
determining, in a case where the ratio is less than or equal to a threshold and the second time domain resource for transmitting the demodulation reference signal and not overlapping with the time domain resource of the second resource exists in the time domain resource for the terminal to transmit the physical uplink shared channel, the second time domain resource as the time domain resource of the available third resource.

17. The method according to claim 10, further comprising:
determining the first resource according to a related parameter of a first demodulation reference signal pattern of a plurality of demodulation reference signal patterns configured for the terminal, and
wherein determining the available third resource comprises:
determining the available third resource according to a related parameter of a second demodulation reference signal pattern of the plurality of demodulation reference signal patterns.

18. The method according to claim 10, wherein the second resource comprises a rate matching resource.

19.-21. (canceled)

22. A communication device, comprising:
one or more processors; and
a memory configured to store a computer program,
wherein the computer program, when collectively executed by the one or more processors, causes the communication device to act as a terminal and:
determine that a first resource for transmitting a demodulation reference signal of a physical uplink shared channel overlaps with a second resource in an uplink subband configured for the terminal, wherein the second resource is not used for transmitting the demodulation reference signal, and
determine an available third resource, and transmit the demodulation reference signal on the available third resource.

23. A communication device, comprising:
one or more processors; and
a memory configured to store a computer program, and
wherein the computer program, when collectively executed by the one or more processors, causes the communication device to act as a network device and perform the method for determining resources according to claim 10.

24.-25. (canceled)
